(19) United States
(12) Patent Application Publication
(10) Pub. No.: US 2025/0145275 A1
(43) Pub. Date: May 8, 2025

(54) SYSTEM AND METHOD FOR PROPULSOR CONTROL FOR AN ELECTRIC AIRCRAFT

(71) Applicant: BETA AIR LLC, South Burlington, VT (US)

(72) Inventor: Kyle Brookes, Richmond, VT (US)

(21) Appl. No.: 19/018,764

(22) Filed: Jan. 13, 2025

Related U.S. Application Data
(63) Continuation of application No. 17/966,804, filed on Oct. 15, 2022.

(51) Int. Cl. B64C 11/44; B64C 29/00; B64D 27/24

(52) U.S. Cl. CPC B64C 11/44; B64C 29/0025; B64D 27/24

(57) ABSTRACT

Disclosed herein are systems and methods for propulsor cyclic control. Propulsor cyclic control may be used to reduce asymmetric loads in aircraft flight. A system for propulsor cyclic control may include an electric aircraft comprising a motor, a propulsor, and a cyclic. Cyclic may be controlled passively or actively.

### CROSS-REFERENCE TO RELATED APPLICATION

This application is a continuation of, and claims priority to, U.S. patent application Ser. No. 17/966,804, filed on Oct. 15, 2022, the disclosure of which is incorporated herein by reference in its entirety.

### FIELD OF THE INVENTION

The present invention generally relates to the field of aircraft. In particular, the present invention is directed to a system and method for propulsor cyclic control on an electric aircraft.

### BACKGROUND

Edgewise flight can cause non-axial strain on rotors and corresponding drive systems of an aircraft. Such strain results in expediated aging and wear of drive systems. Existing solutions to this problem are not sufficient.

### SUMMARY OF THE DISCLOSURE

In an aspect, a system for propulsor cyclic control on an electric aircraft, wherein the system includes an electric aircraft including a motor, a propulsor driven by the motor and comprising a solid blade and configured to propel the electric aircraft, and a cyclic attached to the propulsor and configured to vary the angle of attack of the propulsor as a function of the rotational position of the propulsor.

In another aspect, a method for propulsor cyclic control on an electric aircraft, the method includes receiving a motor, propelling an electric aircraft using a propulsor driven by the motor, and varying the angle of attack of the propulsor, by a cyclic, as a function of the rotational position of the propulsor.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an illustration of an exemplary aircraft in one or more aspects of the present disclosure;

FIG. 2 is a block diagram of a system for propulsor cyclic control on an electric aircraft;

FIG. 3 is an illustration showing an exploded view of an exemplary embodiment of an electric motor in a propulsion assembly in one or more aspects of the present disclosure;

FIGS. 4A and 4B are illustrations showing cross-sectional views of an exemplary embodiment of a rotor for an electric aircraft motor in one or more aspects of the present disclosure;

FIG. 5 is an exemplary embodiment of a propulsor blade;

FIG. 6 is a block diagram of an exemplary flight controller;

FIG. 7 is a flow diagram of method for propulsor cyclic control; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are used to mitigate forces from edgewise flight on an aircraft. Often times, propulsors are subjected to tremendous shear forces and loads due to external conditions such as wind. To mitigate those forces, cyclic control may be used. In an embodiment, aspects of this present disclosure may also include a flight controller configured to command a cyclic.

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

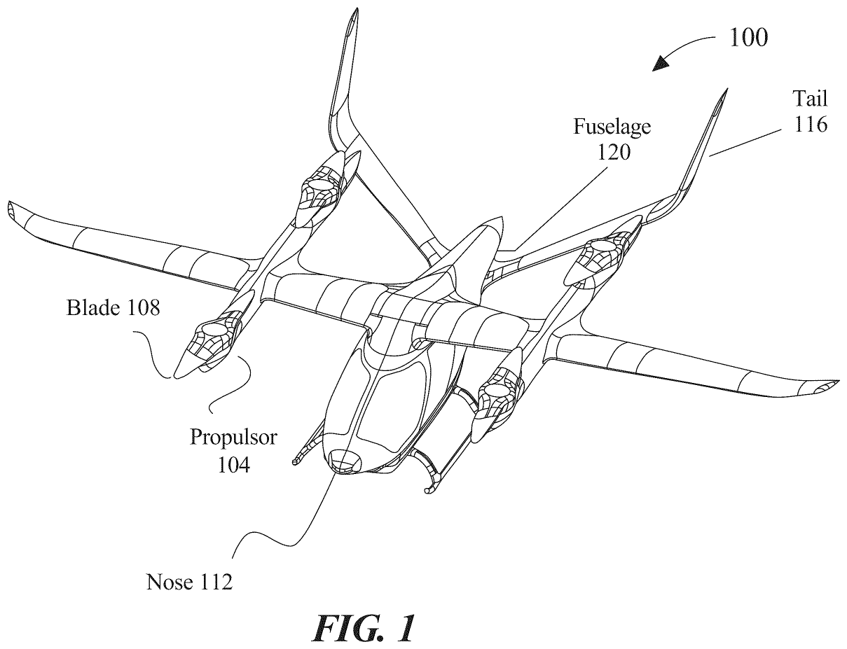

Referring now to FIG. 1, an exemplary embodiment of an electric aircraft 100 with a propulsor 104 is illustrated in accordance with one or more embodiments of the present disclosure. As used in this disclosure an “aircraft” is any vehicle that may fly by gaining support from the air. As a non-limiting example, aircraft may include airplanes, helicopters, commercial and/or recreational aircrafts, instrument flight aircrafts, drones, electric aircrafts, airliners, rotorcrafts, vertical takeoff and landing aircrafts, jets, airships, blimps, gliders, paramotors, and the like. Aircraft 100 may include an electrically powered aircraft. In embodiments, electrically powered aircraft may be an electric vertical takeoff and landing (eVTOL) aircraft. Electric aircraft may be capable of rotor-based cruising flight, rotor-based takeoff, rotor-based landing, fixed-wing cruising flight, airplane-style takeoff, airplane-style landing, and/or any combination thereof. Electric aircraft may include one or more manned and/or unmanned aircrafts. Electric aircraft may include one or more all-electric short takeoff and landing (eSTOL) aircrafts. For example, and without limitation, eVTOL aircrafts may accelerate plane to a flight speed on takeoff and decelerate plane after landing. In an embodiment, and without limitation, electric aircraft may be configured with an electric propulsion assembly. Electric propulsion assembly may include any electric propulsion assembly as described in U.S. Nonprovisional application Ser. No. 16/603,225, filed on Dec. 4, 2019, and entitled “AN INTEGRATED ELECTRIC PROPULSION ASSEMBLY,” the entirety of which is incorporated herein by reference.

Still referencing FIG. 1, and as used in this disclosure, an electric vertical take-off and landing (eVTOL) aircraft is an aircraft that can hover, take off, and land vertically. An eVTOL, as used in this disclosure, is an electrically powered aircraft typically using an energy source, of a plurality of energy sources to power aircraft. To optimize the power and energy necessary to propel aircraft 100, eVTOL aircraft may be capable of rotor-based cruising flight, rotor-based takeoff, rotor-based landing, fixed-wing cruising flight, airplane-style takeoff, airplane style landing, and/or any combination thereof. Rotor-based flight, as described herein, is where the aircraft generates lift and propulsion by way of one or more powered rotors or blades coupled with an engine, such as a “quad-copter,” multi-rotor helicopter, or other vehicle that maintains its lift primarily using downward thrusting propulsors. “Fixed-wing flight”, as described herein, is where an aircraft is capable of flight using wings and/or foils that generate lift caused by the aircraft's forward airspeed and the shape of the wings and/or foils, such as airplane-style flight.

Still referencing FIG. 1, and in one or more embodiments, aircraft 100 may include motor, which may be mounted on a structural feature of an aircraft. Design of motor may enable it to be installed external to the structural member (such as a boom, nacelle, or fuselage) for easy maintenance access and to minimize accessibility requirements for the structure. This may improve structural efficiency by requiring fewer large holes in the mounting area. This design may include two main holes in the top and bottom of the mounting area to access bearing cartridge. Further, a structural feature may include a component of aircraft 100. For example, and without limitation structural feature may be any portion of a vehicle incorporating motor, including any vehicle as described below. As a further non-limiting example, a structural feature may include without limitation a wing, a spar, an outrigger, a fuselage, or any portion thereof; persons skilled in the art, upon reviewing the entirety of this disclosure, will be aware of many possible features that may function as at least a structural feature. At least a structural feature may be constructed of any suitable material or combination of materials, including without limitation metal such as aluminum, titanium, steel, or the like, polymer materials or composites, fiberglass, carbon fiber, wood, or any other suitable material. As a non-limiting example, at least a structural feature may be constructed from additively manufactured polymer material with a carbon fiber exterior; aluminum parts or other elements may be enclosed for structural strength, or for purposes of supporting, for instance, vibration, torque or shear stresses imposed by at least propulsor 104. Persons skilled in the art, upon reviewing the entirety of this disclosure, will be aware of various materials, combinations of materials, and/or constructions techniques.

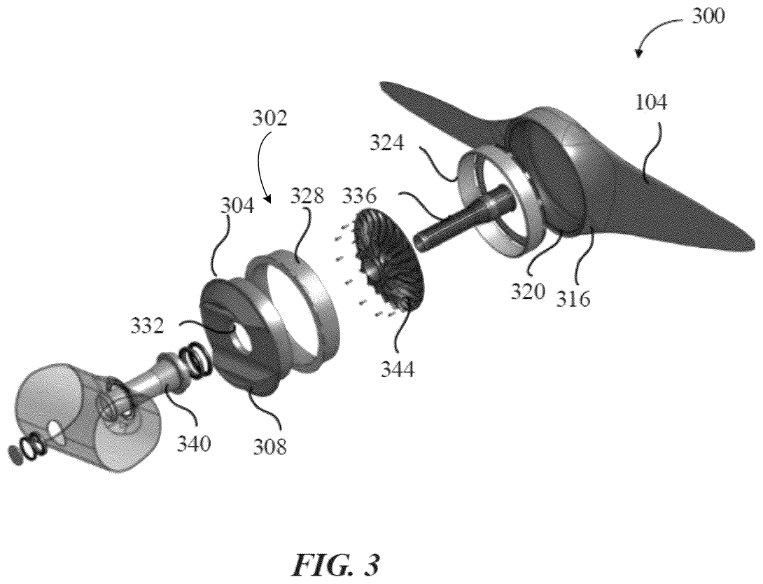

Still referring to FIG. 1, aircraft 100 may include a propulsor 104. For the purposes of this disclosure, a “propulsor” is a component or device used to propel a craft by exerting force on a fluid medium, which may include a gaseous medium such as air or a liquid medium such as water. Propulsor may include any device or component that consumes electrical power on demand to propel an electric aircraft in a direction or other vehicle while on ground or in-flight. For example, and without limitation, propulsor may include a rotor, propeller, paddle wheel, and the like thereof. In an embodiment, propulsor may include a plurality of blades. As used in this disclosure a “blade” is a propeller that converts rotary motion from an engine or other power source into a swirling slipstream. In an embodiment, blade may convert rotary motion to push the propeller forwards or backwards. In an embodiment, propulsor may include a rotating power-driven hub, to which are attached several radial airfoil-section blades such that the whole assembly rotates about a longitudinal axis. In one or more embodiments, a rotor may be used in a motor of a lift propulsor, which is further described in this disclosure with reference to FIG. 3. For the purposes of this disclosure, a “lift propulsor” is a propulsor that produces lift. In one or more exemplary embodiments, propulsor 104 may include a vertical propulsor or a forward propulsor. A forward propulsor may include a propulsor configured to propel aircraft 100 in a forward direction. A vertical propulsor may include a propulsor configured to propel aircraft 100 in an upward direction. One of ordinary skill in the art would understand upward to comprise the imaginary axis protruding from the earth at a normal angle, configured to be normal to any tangent plane to a point on a sphere (i.e. skyward). In an embodiment, vertical propulsor can be a propulsor that generates a substantially downward thrust, tending to propel an aircraft in an opposite, vertical direction and provides thrust for maneuvers. Such maneuvers can include, without limitation, vertical take-off, vertical landing, hovering, and/or rotor-based flight such as “quadcopter” or similar styles of flight.

Still referencing FIG. 1, and in an embodiment, propulsor 104 may include a propeller, a blade, or the like. The function of a propeller is to convert rotary motion from an engine or other power source into a swirling slipstream which pushes the propeller forwards or backwards. The propulsor may include a rotating power-driven hub, to which are attached several radial airfoil-section blades such that the whole assembly rotates about a longitudinal axis. The blade pitch of a propeller may, for example, be fixed, manually variable to a few set positions, automatically variable (e.g. a “constant-speed” type), or any combination thereof. In an exemplary embodiment, propellers for an aircraft may be designed to be fixed to their hub at an angle similar to the thread on a screw makes an angle to the shaft; this angle may be referred to as a pitch or pitch angle which will determine the speed of the forward movement as the blade rotates.

Still referencing FIG. 1, and in an embodiment, a propulsor can include a thrust element which may be integrated into the propulsor. The thrust element may include, without limitation, a device using moving or rotating foils, such as one or more rotors, an airscrew or propeller, a set of airscrews or propellers such as contra-rotating propellers, a moving or flapping wing, or the like. Further, a thrust element, for example, can include without limitation a marine propeller or screw, an impeller, a turbine, a pump-jet, a paddle or paddle-based device, or the like.

Still referring to FIG. 1, a propulsor may include a pusher component. As used in this disclosure a “pusher component” is a component that pushes and/or thrusts an aircraft through a medium. As a non-limiting example, pusher component may include a pusher propeller, a paddle wheel, a pusher motor, a pusher propulsor, and the like. Pusher component may be configured to produce a forward thrust. As used in this disclosure a “forward thrust” is a thrust that forces aircraft through a medium in a horizontal direction, wherein a horizontal direction is a direction parallel to the longitudinal axis. For example, forward thrust may include a force of 1145 N to force aircraft to in a horizontal direction along the longitudinal axis. As a further non-limiting example, pusher component may twist and/or rotate to pull air behind it and, at the same time, push aircraft 100 forward with an equal amount of force. In an embodiment, and without limitation, the more air forced behind aircraft, the greater the thrust force with which aircraft 100 is pushed horizontally will be. In another embodiment, and without limitation, forward thrust may force aircraft 100 through the medium of relative air. Additionally or alternatively, plurality of propulsors may include one or more puller components. As used in this disclosure a “puller component” is a component that pulls and/or tows an aircraft through a medium. As a non-limiting example, puller component may include a flight component such as a puller propeller, a puller motor, a tractor propeller, a puller propulsor, and the like. Additionally, or alternatively, puller component may include a plurality of puller flight components.

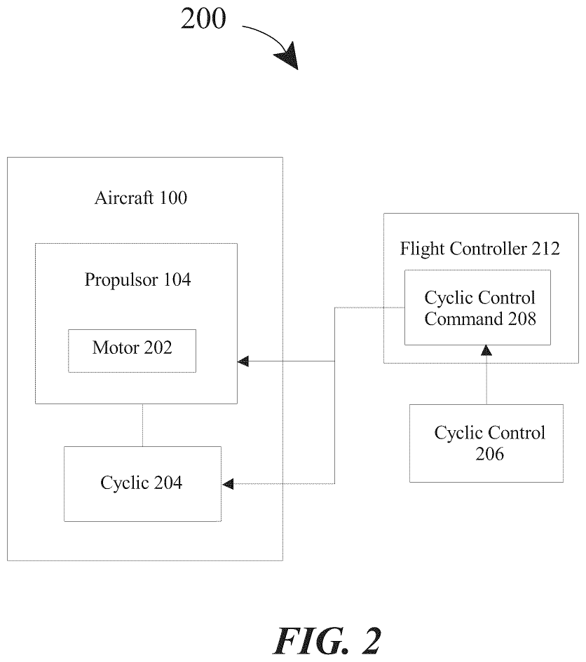

Continuing to reference FIG. 1, and in one or more embodiments, propulsor 104 includes a motor 302 (not shown in FIG. 1; see FIG. 3). Motor 302 may include, without limitation, any electric motor, where an electric motor is a device that converts electrical energy into mechanical energy, for instance by causing a shaft to rotate. A motor may be driven by direct current (DC) electric power; for instance, a motor may include a brushed DC motor or the like. A motor may be driven by electric power having varying or reversing voltage levels, such as alternating current (AC) power as produced by an alternating current generator and/or inverter, or otherwise varying power, such as produced by a switching power source. A motor may include, without limitation, a brushless DC electric motor, a permanent magnet synchronous motor, a switched reluctance motor, and/or an induction motor; persons skilled in the art, upon reviewing the entirety of this disclosure, will be aware of various alternative or additional forms and/or configurations that a motor may take or exemplify as consistent with this disclosure. In addition to inverter and/or switching power source, a circuit driving motor may include electronic speed controllers (not shown) or other components for regulating motor speed, rotation direction, torque, and the like. Continuing to reference FIG. 1, propulsor 104 may include two or more blades 108. In an embodiment, a propulsor 104 may include an advancing blade and a retreating blade. An advancing blade moves towards a nose 112 of an aircraft and a retreating blade moves towards a tail 116 of an aircraft. Blades 108 may be solid blades. As used herein, a “solid blade” is a blade such that is substantially rigid and not susceptible to bending during flight. Blade pitch on solid blades may not be individually adjustable, therefore cyclic controls may only control the blade pitch as a whole. Specifically, the advancing blade and the retreating blade may be considered a solid blade together and may not be individually adjusted and may be adjusted as a whole. As used herein, “blade pitch” is the angle of a blade. Cyclic controls are discussed in further detail in FIG. 2.

Continuing to reference FIG. 1, aircraft 100 may include a fuselage 120. In one or more embodiments, and as used in this disclosure, a “fuselage” is a main body of an aircraft. In one or more embodiments, fuselage 120 may include the entirety of aircraft except for a cockpit, nose, wings, empennage, nacelles, flight components, such as any and all control surfaces and propulsors. Fuselage 120 may contain a payload of aircraft. In one or more embodiments, airframe may form fuselage 120. For example, and without limitation, one or more structural elements of airframe may be used to form fuselage 120. For the purposes of this disclosure, “structural elements” include elements that physically support a shape and structure of an aircraft. Structural elements may take a plurality of forms, alone or in combination with other types. In one or more embodiments, a structural element may include a carbon fiber composite structure, as previously mentioned. The carbon fiber composite structure is configured to include high stiffness, high tensile strength, low weight to strength ratio, high chemical resistance, high temperature tolerance, and low thermal expansion. In one or more embodiments, a carbon fiber composite may include one or more carbon fiber structures comprising a plastic resin and/or graphite. For example, a carbon fiber composite may be formed as a function of a binding carbon fiber to a thermoset resin, such as an epoxy, and/or a thermoplastic polymer, such as polyester, vinyl ester, nylon, and the like thereof. Structural element may vary depending on a construction type of aircraft. For example, and without limitation, structural element may vary if forming the portion of aircraft that is fuselage 120. Fuselage 120 may include a truss structure. A truss structure may be used with a lightweight aircraft and include welded steel tube trusses. A “truss,” as used in this disclosure, is an assembly of beams that create a rigid structure, often in combinations of triangles to create three-dimensional shapes. A truss structure may alternatively comprise wood construction in place of steel tubes, or a combination thereof. In embodiments, structural elements may include steel tubes and/or wood beams.

Referring now to FIG. 2, a system 200 for propulsor cyclic control on an electric aircraft is shown. System 200 includes a propulsor 104 configured to propel aircraft 100. Aircraft 100, as discussed above, may be an electric vertical takeoff and landing aircraft (eVTOL). Propulsor 104 may be a lift propulsor. Propulsor 104 may include solid blades, as discussed above. In an embodiment, system 200 may be used to reduce asymmetric loads due to flight. In edgewise flight, for example, these lift propulsors may experience significant off axis torque due to the asymmetrical forces as the propulsor blades are travelling horizontally through the air. This torque may be transferred to the rotating mechanisms of the system, such as the rotors, and can cause significant stress or damage to the drive motors (e.g. direct drive motors) due to shrinkage in size of clearance gaps and undesirable contact between components. As used in this disclosure, “edgewise flight” is a flight orientation wherein an air stream is substantially directed at an edge of a propeller. Edgewise flight (exaggerated for explanation) may occur when an aircraft is traveling in a direction orthogonal to a rotational axis of a propeller and parallel to a rotation plane of the propeller, causing an air stream to be directed at an edge of the propeller. Edgewise flight may also occur when an aircraft is traveling in a direction in which a component of the velocity of the aircraft is in a direction orthogonal to a rotational axis of a propulsor and parallel to rotation plane.

Continuing to reference FIG. 2, system 200 includes a motor 202. A motor 202 may be consistent with any motor as discussed herein. In one or more embodiments, motor may be configured to power propulsor 104. Motor may include a rotor, stator, motor shaft, and the like, as shown, as a non-limiting example, in FIG. 3. Motor may be at least partially disposed in an airframe of aircraft 100, such as a boom or a wing of aircraft 100. Rotor of motor may rotate about a central axis of motor. As used in this disclosure, a “motor” is a device, such as an electric motor, that converts electrical energy into mechanical movement. Motor 202 may include an electric motor. Electric motor may be driven by direct current (DC) electric power. As an example, and without limitation, electric motor may include a brushed DC electric motor or the like. An electric motor may be, without limitation, driven by electric power having varying or reversing voltage levels, such as alternating current (AC) power as produced by an alternating current generator and/or inverter, or otherwise varying power, such as produced by a switching power source. Electric motor may include, for example and without limitation, brushless DC electric motors, permanent magnet synchronous an electric motor, switched reluctance motors, induction motors, and the like. In addition to an inverter and/or a switching power source, a circuit driving electric motor may include electronic speed controllers (not shown) or other components for regulating motor speed, rotation direction, and/or dynamic braking. Motor may be used in an electric vehicle such as an electric automobile and an electric aircraft, including an electrical vertical takeoff and landing (eVTOL) aircraft, a commercial aircraft, an unmanned aerial vehicle, a rotorcraft, and the like. Propulsor assembly components may be consistent with disclosure of propulsor assembly components in U.S. patent application Ser. No. 17/563,498 filed on Dec. 28, 2021 and titled “AN ELECTRIC AIRCRAFT LIFT MOTOR WITH AIR COOLING”, in U.S. patent application Ser. No. 17/732,791 filed on Apr. 29, 2022 and titled “MAGNETIC LOCKING SYSTEM OF AN ELECTRIC AIRCRAFT ROTOR AND METHODS THEREOF”, in U.S. patent application Ser. No. 17/702,069 filed on Mar. 23, 2022 and titled “A DUAL-MOTOR PROPULSION ASSEMBLY”, in U.S. patent application Ser. No. 17/704,798 filed on Mar. 25, 2022 and titled “ROTOR FOR AN ELECTRIC AIRCRAFT MOTOR”, all of which are incorporated by reference herein in their entirety.

Still referencing FIG. 2, system 200 includes a cyclic 204. As used herein, a “cyclic” is a device configured to control a rotor to change a direction of movement. A cyclic may be used to control a rotor of a propulsor 104 to change a pitch of the propulsor blades as a function of rotational position. A cyclic control 206 may be located in a fuselage of an aircraft 100. As used herein, a “cyclic control” is a device to control a cyclic. For example, a cyclic control 206 may be a joystick, control stick, lever, button, or the like. Fuselage is shown in FIG. 1. Specifically, a cyclic control 206 may be located next to a pilot's seat. Alternatively, cyclic control 206 may be located remotely from aircraft 100 in another location, while being communicatively connected to aircraft 100. “Communicatively connected”, for the purposes of this disclosure, is a process whereby one device, component, or circuit is able to receive data from and/or transmit data to another device, component, or circuit; communicative connecting may be performed by wired or wireless electronic communication, either directly or by way of one or more intervening devices or components. In an embodiment, communicative connecting includes electrically coupling an output of one device, component, or circuit to an input of another device, component, or circuit. Communicative connecting may be performed via a bus or other facility for intercommunication between elements of a computing device. Communicative connecting may include indirect connections via “wireless” connection, low power wide area network, radio communication, optical communication, magnetic, capacitive, or optical coupling, or the like.

Continuing to reference FIG. 2, cyclic control 206 may be configured to generate a cyclic control command 208. Cyclic control command 208 may be generated as a function of a pilot input. As used herein, a “pilot input” is a manipulation of one or more elements that corresponds to a desire to affect an aircraft's state. For example, a pilot input may be a manipulation of cyclic control 206 to change an aircraft's direction. In an embodiment, manipulation of cyclic control 206 may include forward, backward, left, or right pilot inputs. Forward pilot input may be an input in the direction of the nose of the aircraft 100. Backwards pilot input may be an input in the direction of the tail of the aircraft 100. Left pilot input may perpendicular and to the left of the forward pilot input. Right pilot input may be perpendicular and to the right of the forward pilot input. Forward and backward pilot input may correspond to a change in pitch attitude of aircraft 100, which may result in climbing or descending flight. Left and right pilot input may correspond to a change in roll of the aircraft 100, which may result in a change in direction of the aircraft 100. As used herein, “cyclic control command” is a signal describing the pilot input. Cyclic control command may include an electronic signal from the physical manipulation of a pilot input, such as pulling a lever or pushing a button. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sine function, or pulse width modulated signal. A sensor may include circuitry, computing devices, electronic components or a combination thereof that translates pilot input into a cyclic control command 208 configured to be transmitted to any other electronic component. A sensor may be located on, near, or remote from cyclic 204 and/or cyclic control 206. Additionally, cyclic control 206 may be used to adjust a max change in pitch of a propulsor blade. For example, a pilot input and/or a flight controller 212 may set a max change in pitch of 15°, 10°, 1°, or the like. In such instances, cyclic 204 may only vary the angle of attack of the propulsor up to the max change in pitch angle. For the purposes of this disclosure, a “max change” is the maximum allowed change in the pitch of a propulsor blade that is permitted. In some embodiments, max change may be a limit that is imposed by flight controller 212.

Continuing to reference FIG. 2, a flight controller 212 is communicatively connected to propulsor 104, cyclic 204, and/or cyclic control 206. Flight controller 212 may include any computing device as described in this disclosure, including without limitation a micro flight controller, processor, microprocessor, digital signal processor (DSP), and/or system on a chip (SoC) as described in this disclosure. Computing device may include, be included in, and/or communicate with a mobile device such as a mobile telephone or smartphone. Flight controller 212 may include a single computing device operating independently, or may include two or more computing device operating in concert, in parallel, sequentially or the like; two or more computing devices may be included together in a single computing device or in two or more computing devices. Flight controller 212 may interface or communicate with one or more additional devices as described below in further detail via a network interface device. Network interface device may be utilized for connecting flight controller 212 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used.

Information (e.g., data, software etc.) may be communicated to and/or from a computer and/or a computing device. Flight controller 212 may include but is not limited to, for example, a computing device or cluster of computing devices in a first location and a second computing device or cluster of computing devices in a second location. Flight controller 212 may include one or more computing devices dedicated to data storage, security, distribution of traffic for load balancing, and the like. Flight controller 212 may distribute one or more computing tasks as described below across a plurality of computing devices of computing device, which may operate in parallel, in series, redundantly, or in any other manner used for distribution of tasks or memory between computing devices. Flight controller 212 may be implemented using a “shared nothing” architecture in which data is cached at the worker, in an embodiment, this may enable scalability of system 200 and/or computing device.

With continued reference to FIG. 2, flight controller 212 may be designed and/or configured to perform any method, method step, or sequence of method steps in any embodiment described in this disclosure, in any order and with any degree of repetition. For instance, flight controller 212 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller 212 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

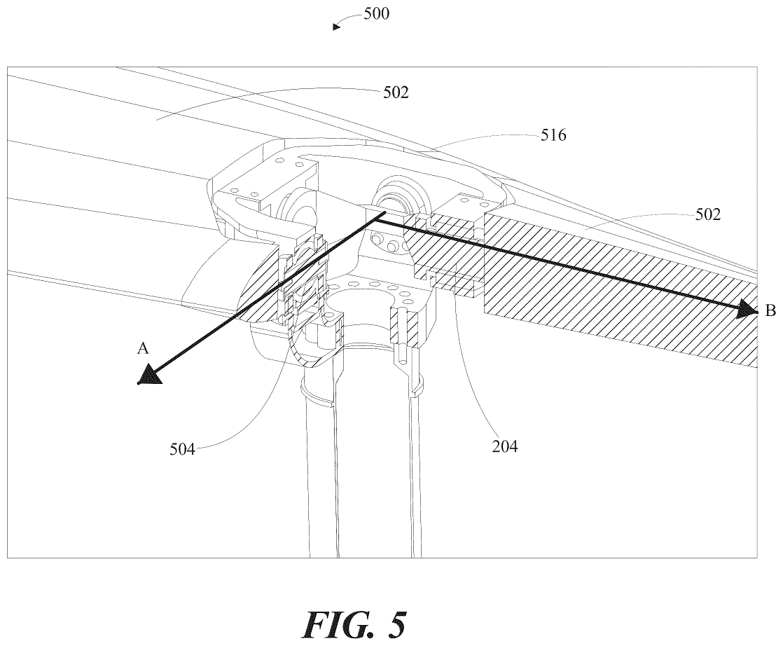

Continuing to reference FIG. 2, flight controller 212 may be configured to receive the cyclic control command 208 from the cyclic control 206 and adjust the propulsor 104 and/or cyclic 204 as a function of the cyclic control command 208. In an embodiment, cyclic control command 208 may be configured to control the angle of attack of a blade/blades. This may occur at any point during the 360-degree rotation of a blade. The angle of attack (AOA) is an angle between the body's reference line and the oncoming flow. In aerodynamics, angle of attack may specify the angle between a chord line of a wing of an aircraft and a vector representing a relative motion between the aircraft and atmosphere. In an embodiment, cyclic control command 208 may control blade pitch, wherein blade pitch is the angle of attack of a blade. In an embodiment, the ability to vary blade pitch may allow for lower forces on the rotors, as the rotors may not be completely rigid. In some embodiments, cyclic control command 208 may control max blade pitch, as discussed above. In an embodiment, flight controller 212 may actuate and/or adjust a rotor to control an angle of attack of propulsor blades. In some embodiments, cyclic control of blades of propulsor 104 may be active or passive. Active control of blades may include using actuators to maintain a position of propulsor blades. Passive control of blades may include allowing blades to flap due to aerodynamic forces acting on propulsor 104. Blade flapping may be used to counter asymmetric loads due to flight, as discussed above. Blade flapping may allow blades to respond to wind vectors created by the external environment of aircraft 100, which may allow blades to overcome aerodynamic differences over the blades. For example, there may be differences in lift and drag in the blades due to wind vectors and aircraft speed. Passive control of blades may also include using mechanical devices, such as springs, dampers, and the like, to adjust blade pitch. Damping devices are disclosed further with reference to FIG. 5. Mechanical devices may be used to equalize lift across the propulsor/rotor.

Still referencing FIG. 2, flight controller 212 may be configured to control a feedback mechanism and/or feedforward mechanism of the cyclic 204. Flight controller 212 may use airspeed of aircraft 100 to control/adjust cyclic 204. For example, for a given airspeed, flight controller 212 may adjust the max blade pitch of a propulsor 104. In some embodiments, a higher airspeed may equate to a larger max blade pitch. Additionally, or alternatively, flight controller 212 may control cyclic 204 using feedback from cyclic 204, such as from sensors on cyclic 204. In some embodiments, a high force on cyclic 204 and/or the rotor of the motor 202 may result in flight controller 212 adjusting the blade pitch. In other embodiments, feedback such as a detected change in airspeed of aircraft 100 may cause flight controller 212 to adjust the blade pitch.

Referring now to FIG. 3, an embodiment of an integrated electric propulsion assembly 300 is illustrated. Integrated electric propulsion assembly 300 may include at least a stator 304. Stator 304, as used herein, is a stationary component of a motor and/or motor assembly. In an embodiment, stator 304 includes at least a first magnetic element 308. As used herein, first magnetic element 308 is an element that generates a magnetic field. For example, first magnetic element 308 may include one or more magnets which may be assembled in rows along a structural casing component. Further, first magnetic element 308 may include one or more magnets having magnetic poles oriented in at least a first direction. The magnets may include at least a permanent magnet. Permanent magnets may be composed of, but are not limited to, ceramic, alnico, samarium cobalt, neodymium iron boron materials, any rare earth magnets, and the like. Further, the magnets may include an electromagnet. As used herein, an electromagnet is an electrical component that generates magnetic field via induction; the electromagnet may include a coil of electrically conducting material, through which an electric current flow to generate the magnetic field, also called a field coil of field winding. A coil may be wound around a magnetic core, which may include without limitation an iron core or other magnetic material. The core may include a plurality of steel rings insulated from one another and then laminated together; the steel rings may include slots in which the conducting wire will wrap around to form a coil. A first magnetic element 308 may act to produce or generate a magnetic field to cause other magnetic elements to rotate, as described in further detail below. Stator 304 may include a frame to house components including at least a first magnetic element 308, as well as one or more other elements or components as described in further detail below. In an embodiment, a magnetic field can be generated by a first magnetic element 308 and can comprise a variable magnetic field. In embodiments, a variable magnetic field may be achieved by use of an inverter, a controller, or the like. In an embodiment, stator 304 may have an inner and outer cylindrical surface; a plurality of magnetic poles may extend outward from the outer cylindrical surface of the stator. In an embodiment, stator 304 may include an annular stator, wherein the stator is ring-shaped. In an embodiment, stator 304 is incorporated into a DC motor where stator 304 is fixed and functions to supply the magnetic fields where a corresponding rotor, as described in further detail below, rotates.

Still referring to FIG. 3, integrated electric propulsion assembly 300 may include a propulsor 104. In embodiments, propulsor 104 can include an integrated rotor. As used herein, a rotor is a portion of an electric motor that rotates with respect to a stator of the electric motor, such as stator 304. A propulsor, as used herein, is a component or device used to propel a craft by exerting force on a fluid medium, which may include a gaseous medium such as air or a liquid medium such as water. Propulsor 104 may be any device or component that consumes electrical power on demand to propel an aircraft or other vehicle while on ground and/or in flight. Propulsor 104 may include one or more propulsive devices. In an embodiment, propulsor 104 can include a thrust element which may be integrated into the propulsor. A thrust element may include any device or component that converts the mechanical energy of a motor, for instance in the form of rotational motion of a shaft, into thrust in a fluid medium. For example, a thrust element may include without limitation a marine propeller or screw, an impeller, a turbine, a pump-jet, a paddle or paddle-based device, or the like. As another non-limiting example, at least a propulsor may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as at least a thrust element. As used herein, a propulsive device may include, without limitation, a device using moving or rotating foils, including without limitation one or more rotors, an airscrew or propeller, a set of airscrews or propellers such as contra-rotating propellers, a moving or flapping wing, or the like.

In an embodiment, propulsor 104 may include at least a blade. As another non-limiting example, a propulsor may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as propulsor 104. In an embodiment, when a propulsor twists and pulls air behind it, it will, at the same time, push the aircraft forward with an equal amount of force. The more air pulled behind the aircraft, the more the aircraft is pushed forward.

In an embodiment, thrust element may include a helicopter rotor incorporated into propulsor 104. A helicopter rotor, as used herein, may include one or more blade or wing elements driven in a rotary motion to drive fluid medium in a direction axial to the rotation of the blade or wing element. Its rotation is due to the interaction between the windings and magnetic fields which produces a torque around the rotor's axis. A helicopter rotor may include a plurality of blade or wing elements.

Continuing to refer to FIG. 3, propulsor 104 can include a hub 316 rotatably mounted to stator 304. Rotatably mounted, as described herein, is functionally secured in a manner to allow rotation. Hub 316 is a structure which allows for the mechanically connected of components of the integrated rotor assembly. In an embodiment, hub 316 can be mechanically connected to propellers or blades. In an embodiment, hub 316 may be cylindrical in shape such that it may be mechanically joined to other components of the rotor assembly. Hub 316 may be constructed of any suitable material or combination of materials, including without limitation metal such as aluminum, titanium, steel, or the like, polymer materials or composites, fiberglass, carbon fiber, wood, or any other suitable material. Hub 316 may move in a rotational manner driven by interaction between stator and components in the rotor assembly. Persons skilled in the art, upon reviewing the entirety of this disclosure, will be aware of various structures that may be used as or included as hub 316, as used and described herein.

Still referring to FIG. 3, propulsor 104 can include a second magnetic element 320, which may include one or more further magnetic elements. Second magnetic element 320 generates a magnetic field designed to interact with first magnetic element 308. Second magnetic element 320 may be designed with a material such that the magnetic poles of at least a second magnetic element are oriented in an opposite direction from first magnetic element 308. In an embodiment, second magnetic element 320 may be affixed to hub 316. Affixed, as described herein, is the attachment, fastening, connection, and the like, of one component to another component. For example, and without limitation, affixed may include bonding the second magnetic element 320 to hub 316, such as through hardware assembly, spot welding, riveting, brazing, soldering, glue, and the like. Second magnetic element 320 may include any magnetic element suitable for use as a first magnetic element 308. For instance, and without limitation, second magnetic element may include a permanent magnet and/or an electromagnet. Second magnetic element 320 may include magnetic poles oriented in a second direction opposite of the orientation of the poles of first magnetic element 308. In an embodiment, electric propulsion assembly 300 includes a motor assembly incorporating stator 304 with a first magnet element and second magnetic element 320. First magnetic element 308 includes magnetic poles oriented in a first direction, a second magnetic element includes a plurality of magnetic poles oriented in the opposite direction than the plurality of magnetic poles in the first magnetic element 308.

Continuing to refer to FIG. 3, second magnetic element 320 may include a plurality of magnets attached to or integrated in hub 316. In an embodiment, hub 316 may incorporate structural elements of the rotor assembly of the motor assembly. As a non-limiting example hub 316 may include a motor inner magnet carrier 324 and motor outer magnet carrier 328 incorporated into the hub 316 structure. In an embodiment motor inner magnet carrier 324 and motor outer magnet carrier 328 may be cylindrical in shape. In an embodiment, motor inner magnet carrier 324 and motor outer magnet carrier 328 may be any shape that would allow for a fit with the other components of the rotor assembly. In an embodiment, hub 316 may be short and wide in shape to reduce the profile height of the rotating assembly of electric propulsion assembly 300. Reducing the profile assembly height may have the advantage of reducing drag force on the external components. In an embodiment, hub 316 may also be cylindrical in shape so that fitment of the components in the rotor assembly are structurally rigid while leaving hub 316 free to rotate about stator.

In an embodiment, motor outer magnet carrier 328 may have a slightly larger diameter than motor inner magnet carrier 324, or vice-versa. First magnetic element 308 may be a productive element, defined herein as an element that produces a varying magnetic field. Productive elements will produce magnetic field that will attract and other magnetic elements, including a receptive element. Second magnetic element may be a productive or receptive element. A receptive element will react due to the magnetic field of a first magnetic element 308. In an embodiment, first magnetic element 308 produces a magnetic field according to magnetic poles of first magnetic element 308 oriented in a first direction. Second magnetic element 320 may produce a magnetic field with magnetic poles in the opposite direction of the first magnetic field, which may cause the two magnetic elements to attract one another. Receptive magnetic element may be slightly larger in diameter than the productive element. Interaction of productive and receptive magnetic elements may produce torque and cause the assembly to rotate. Hub 316 and rotor assembly may both be cylindrical in shape where rotor may have a slightly smaller circumference than hub 316 to allow the joining of both structures. Coupling of hub 316 to stator 304 may be accomplished via a surface modification of either hub 316, stator 304 or both to form a locking mechanism. Coupling may be accomplished using additional nuts, bolts, and/or other fastening apparatuses. In an embodiment, an integrated rotor assembly as described above reduces profile drag in forward flight for an electric aircraft. Profile drag may be caused by a number of external forces that the aircraft is subjected to. By incorporating a propulsor 104 into hub 316, a profile of integrated electric propulsion assembly 300 may be reduced, resulting in a reduced profile drag, as noted above. In an embodiment, the rotor, which includes motor inner magnet carrier 324, motor outer magnet carrier 328, propulsor 104 is incorporated into hub 316 to become one integrated unit. In an embodiment, inner motor magnet carrier 312 rotates in response to a magnetic field. The rotation causes hub 316 to rotate. This unit can be inserted into integrated electric propulsion assembly 300 as one unit. This enables ease of installation, maintenance, and removal.

Still referring to FIG. 3, stator 304 may include a through-hole 332. Through-hole 332 may provide an opening for a component to be inserted through to aid in attaching propulsor with integrated rotor to stator. In an embodiment, through-hole 332 may have a round or cylindrical shape and be located at a rotational axis of stator 304. Hub 316 may be mounted to stator 304 by means of a shaft 336 rotatably inserted though through hole 332. Through-hole 332 may have a diameter that is slightly larger than a diameter of shaft 336 to allow shaft 336 to fit through through-hole 332 to connect stator 304 to hub 316. Shaft 336 may rotate in response to rotation of propulsor 104.

Still referring to FIG. 3, integrated electric propulsion assembly 300 may include a bearing cartridge 340. Bearing cartridge 340 may include a bore. Shaft 336 may be inserted through the bore of bearing cartridge 340. Bearing cartridge 340 may be attached to a structural element of a vehicle. Bearing cartridge 340 functions to support the rotor and to transfer the loads from the motor. Loads may include, without limitation, weight, power, magnetic pull, pitch errors, out of balance situations, and the like. A bearing cartridge 340 may include a bore. a bearing cartridge 340 may include a smooth metal ball or roller that rolls against a smooth inner and outer metal surface. The rollers or balls take the load, allowing the device to spin. a bearing may include, without limitation, a ball bearing, a straight roller bearing, a tapered roller bearing or the like. a bearing cartridge 340 may be subject to a load which may include, without limitation, a radial or a thrust load. Depending on the location of bearing cartridge 340 in the assembly, it may see all of a radial or thrust load or a combination of both. In an embodiment, bearing cartridge 340 may join integrated electric propulsion assembly 300 to a structure feature. A bearing cartridge 340 may function to minimize the structural impact from the transfer of bearing loads during flight and/or to increase energy efficiency and power of propulsor. a bearing cartridge 340 may include a shaft and collar arrangement, wherein a shaft affixed into a collar assembly. A bearing element may support the two joined structures by reducing transmission of vibration from such bearings. Roller (rolling-contact) bearings are conventionally used for locating and supporting machine parts such as rotors or rotating shafts. Typically, the rolling elements of a roller bearing are balls or rollers. In general, a roller bearing is a is type of anti-friction bearing; a roller bearing functions to reduce friction allowing free rotation. Also, a roller bearing may act to transfer loads between rotating and stationary members. In an embodiment, bearing cartridge 340 may act to keep a propulsor 104 and components intact during flight by allowing integrated electric propulsion assembly 300 to rotate freely while resisting loads such as an axial force. In an embodiment, bearing cartridge 340 includes a roller bearing incorporated into the bore. a roller bearing is in contact with propulsor shaft 336. Stator 304 is mechanically coupled to inverter housing defined in the bearing cartridge 340. Mechanically coupled may include a mechanical fastening, without limitation, such as nuts, bolts or other fastening device. Mechanically coupled may include welding or casting or the like. Inverter housing contains a bore which allows insertion by propulsor shaft 336 into bearing cartridge 340.

Still referring to FIG. 3, electric propulsion assembly 300 may include a motor assembly incorporating a rotating assembly and a stationary assembly. Hub 316, motor inner magnet carrier 324 and propulsor shaft 336 may be incorporated into the rotor assembly of electric propulsion assembly 300 which make up rotating parts of electric motor, moving between the stator poles and transmitting the motor power. As one integrated part, the rotor assembly may be inserted and removed in one piece. Stator 304 may be incorporated into the stationary part of the motor assembly. Stator and rotor may combine to form an electric motor. In embodiment, an electric motor may, for instance, incorporate coils of wire which are driven by the magnetic force exerted by a first magnetic field on an electric current. The function of the motor may be to convert electrical energy into mechanical energy. In operation, a wire carrying current may create at least a first magnetic field with magnetic poles in a first orientation which interacts with a second magnetic field with magnetic poles oriented in the opposite direction of the first magnetic pole direction causing a force that may move a rotor in a direction. For example, and without limitation, a first magnetic element 308 in electric propulsion assembly 300 may include an active magnet. For instance, and without limitation, a second magnetic element may include a passive magnet, a magnet that reacts to a magnetic force generated by a first magnetic element 308. In an embodiment, a first magnet positioned around the rotor assembly, may generate magnetic fields to affect the position of the rotor relative to the stator 304. A controller 904 may have an ability to adjust electricity originating from a power supply and, thereby, the magnetic forces generated, to ensure stable rotation of the rotor, independent of the forces induced by the machinery process. Electric propulsion assembly 300 may include an impeller 344 coupled with the shaft 336. An impeller, as described herein, is a rotor used to increase or decrease the pressure and flow of a fluid and/or air. Impeller 344 may function to provide cooling to electric propulsion assembly 300. Impeller 344 may include varying blade configurations, such as radial blades, non-radial blades, semi-circular blades and airfoil blades. Impeller 314 may further include single and/or double-sided configurations.

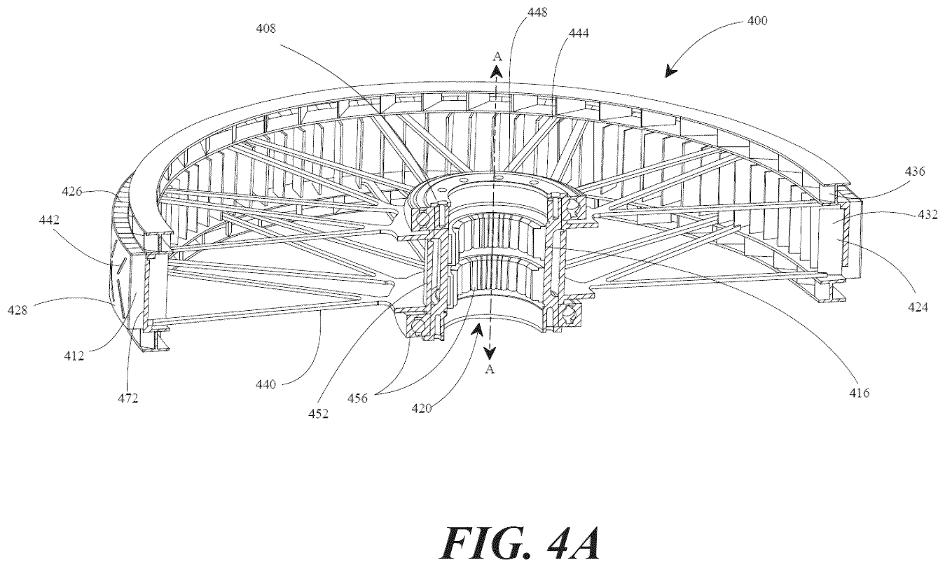

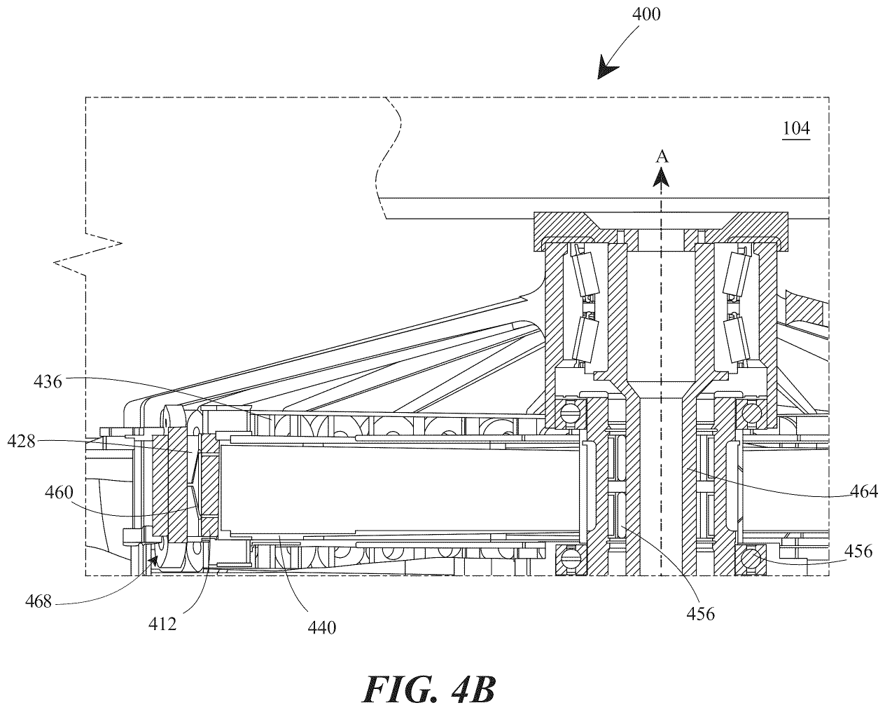

Referring now to FIGS. 4A and 4B, cross-sectional views of an exemplary embodiment of a rotor 400 of a motor of an electric aircraft are shown in accordance with one or more embodiments of the present disclosure. In one or more embodiments, motor may include a lift motor of a propulsor, as discussed further in this disclosure in FIG. 3. In one or more embodiments, rotor 400 includes a hub 408. Hub 408 may be a tubular structure. As used herein, a “hub” is a component that holds the propulsor. Hub 408 may be consistent with any hub as discussed herein. In one or more embodiments, inner surface 416 may define a lumen 420. Lumen 420 may be a longitudinal cavity that receives a roto shaft 464. Shaft 464 may be disposed within lumen 420 of hub 408 so that rotor 400 may rotate and simultaneously rotate shaft 464 which in turn rotates a propulsor. As used in this disclosure, a “lumen” is a central cavity, for example a tubular or cylindrical bore.

With continued reference to FIGS. 4A and 4B, and in one or more embodiments, hub 408 may comprise an inner hub 404 and an outer hub 452. In one or more embodiments, outer hub 452 may be attached to a proximal end 448 of spokes 440 of rotor 400, as discussed further below. In one or more embodiments, inner hub 404 may be secured to outer hub 452 using a locking mechanism. A locking mechanism may be configured to removably attach sprag 456 to hub 408. A locking mechanism may include a bolted joint, dowels, key, spline, and the like. In one or more embodiments, the inner hub 404 may include a sprag 456 defining a clutch, as discussed in more detail below.

With continued reference to FIGS. 4A and 4B, and in one or more embodiments, rotor 400 includes a sprag 456. Sprag 456 may be disposed within inner hub 408. For example, and without limitation, sprag 456 may be attached to an inner surface 416 of inner hub 404. Sprag 456 may engage a rotor shaft (not shown) which allow for the rotational movement of rotor to be translated into a mechanical movement of, for example, a propulsor. Sprag 456 may include a sprag clutch. In one or more embodiments, sprag 456 may have a cage design, so that the sprags are less likely to lay down due to centrifugal force experienced when rotor is spinning. In one or more embodiments, sprag 456 may include a maximum eccentricity of 90 microns.

With continued reference to FIGS. 4A and 4B, rotor 400 includes a hoop 426 concentrically positioned about hub 408. Hoop 426 may share a central axis A with hub 408. In one or more embodiments, hoop 426 includes magnets 412, which are position along an outer circumference of hoop 426 and attached to an outer surface of hoop 426. As used herein, a “magnet” is a material or object that produces a magnetic field. As used herein, a “hoop” is a cylindrical component. In one or more embodiments, a current may flow through a plurality of windings of a stator 468 that then results in the generation of electrically-induced magnetic fields that interact with magnets 412 to rotate rotor 400 about central axis A As used herein, a “stator” is a stationary portion of a motor. During operation, rotor 400 may rotate axially about central axis A while stator remains still; thus, rotor 400 is rotatable relative to stator.

With continued reference to FIGS. 4A and 4B, and in one or more embodiments, magnets 412 of hoop 426 may be permanent magnets fixed to outer surface 472. Magnets 412 may be arranged concentrically to a central axis A of rotor 400. Thus, magnets 412 may be arranged in a ring along the outer circumference of hoop 426, which is defined by outer surface 472 of hoop 426. Magnets 412 may be arranged in a single ring or may be arranged in a plurality of rings along outer surface 472. Each magnet 412 may be positioned adjacent to another magnet 412 along convex outer surface so that stator 468 is continuously interacting with a magnet to produce a rotation of rotor 400. In one or more embodiments, hub 408 and hoop 426 may be made from various materials, such as, for example, steel. In an embodiment, rings and/or layers of rings of magnets 412 may be formed by using adhesive between each of the magnets 412. The adhesive may include epoxy which may be heat cure, UV cure, or the like. The ring of magnets 412 may be formed by stacking layers of magnets 412 on top of one another and using adhesive to adhere adjacent magnetic elements. The magnets may be rare earth magnets, including without limitation Neodymium magnets. Magnets and hoop may be consistent with any magnet or hoop as discussed herein.

With continued reference to FIGS. 4A and 4B, and in one or more embodiments, magnets 412 may include a magnet array. In non-limiting embodiments, a magnet array may include a Halbach array. A Halbach array is a special arrangement of permanent magnets that augments the magnetic field on one side of the array while canceling the field to near zero on the other side of the array. In general, the Halbach array is achieved by having a spatially rotating pattern of magnetization where the poles of successive magnets are not necessarily aligned and differ from one to the next. Orientations of magnetic poles may be repeated in patterns or in successive rows, columns, and arrangements. An array, for the purpose of this disclosure is a set, arrangement, or sequence of items, in this case permanent magnets. The rotating pattern of permanent magnets can be continued indefinitely and have the same effect, and may be arranged in rows, columns, or radially, in a non-limiting illustrative embodiment. One of ordinary skill in the art would appreciate that the area that the Halbach array augments the magnetic field of may be configurable or adjustable.

With continued reference to FIGS. 4A and 4B, and in one or more embodiments, hoop 426 may include cooling features, such as, for example, an integrated radial fan 436 or an integrated axial fan 432. A radial fan 436 may comprise cooling fins 424 positioned on an upper surface of hoop 426 and provide cooling to a stator when rotor 400 is rotating about central axis A. An axial fan may include fins positioned along an inner surface of hoop 426 and provide cooling to motor. Radial fan and/or axial fans may increase air flow in rotor 400 and cause convection cooling. Radial and axial fans may be consistent with motor cooling fans provided in the disclosure U.S. application Ser. No. 47/515,515 titled “AN ELECTRIC AIRCRAFT LIFT MOTOR WITH AIR COOLING”, which is incorporated in this disclosure in its entirety. In one or more embodiments, hoop 426 may include various types of materials, such as for example, titanium, steel, and the like.

Continuing to reference FIGS. 4A and 4B, and in one or more embodiments, a retention band 428 surrounds magnets 412. Additional disclosure on retention bands and magnets are discussed in FIGS. 4 and 5. Retention band 428 may be present around the outer surface of magnets 412. The outer surface of magnets 412 may be the surface opposite the surface in contact with hoop 426. Retention band 428 may be a sleeve of a solid material or an aggregation of individual materials that run along the outer surface of magnets 412. Retention band 428 may be made from various materials, such as stainless steel, titanium, carbon, carbon-composite, and the like. Retention band 428 and magnets 412 may have the same or similar coefficients of thermal expansion. As a result, retention band 428 and/or magnets 412 may expand or shrink at similar rates, allowing for uniform stress around the magnets 412. A similar coefficient of thermal expansion may allow for no point forces to form between the retention band 428 and magnets 412. As used herein, a “retention band” is a component for maintaining a position of the component it is surrounding. For example, a retention band may be configured to maintain a position of magnets 412 by providing inward forces around the magnets 412. For example, retention band 428 may provide stability for rotor 400 and prevent magnets 412 from lifting from outer surface 472 of hoop 426 due to centrifugal forces. Retention band 428 may include slits of various shapes and patterns to provide venting for temperature management purposes. For, example, slits 442 allow for air to pass through retention band 428, allowing air to circulate through rotor 400 when rotor 400 is spinning about central axis A.

Still referencing FIGS. 4A and 4B, retention band 428 may be configured to reduce eddy currents. As used herein, “eddy currents” are loops of electrical current induced by a changing magnetic field. In an embodiment, the rotating stator magnetic field, as discussed in FIG. 3, may cause voltages in the stator and rotor. These voltages may cause small circulating currents to flow, which may be eddy currents. Eddy currents may serve no useful purpose in a motor and result in wasted power. A retention band 428 composed of a poor conductor, such as titanium, steel, plastics, rubber, and the like, may be used to reduce eddy currents. A poor conductor may be a material with a low conductivity. A low conductivity may be less than 3E6 S/m at 20° C. Additionally, the slits of retention band 428 may reduce eddy currents by breakup the area that the currents may circulate in.

With continued reference to FIGS. 4A and 4B, and in one or more embodiments, rotor 400 includes a plurality of spokes 440, that radiate from hub 408 to connect hub 408 and hoop 426. Spokes 440 may extend radially outward from hub 408 to hoop 426. Spokes 440 may be positioned in various arrangement to provide structural support to rotor 400. In one or more embodiments, spokes 440 may be made from various materials, such as steel, titanium and the like. In some embodiments, hoop 426 and spokes 440 may be separate components that may be assembled together. In other embodiments, hoop 426 and spokes 440 may be a monolithic structure. For example, in some cases spokes 440 may include a single element, such as without limitation a disc. Disc may be solid or may include holes. In one or more embodiments, a distal end 444 of each spoke 440 may terminate at and/or be attached to hoop 426, and a proximal end of each spoke 440 may be attached to hub 408.

Now referring to FIG. 5, an embodiment 500 of cyclic control in a propulsor is shown. Embodiment 500 includes a propulsor blade 502 including a hub 516. Propulsor blade 502 may include a cyclic 204 and a teetering mechanism 504. Teetering mechanism 504 may be used to allow for deflections of the propulsor during a transition of flight modes or edgewise flight. Teetering mechanism 504 and cyclic 204 may be used to alleviate asymmetrical forces to the rotor and propulsor assembly as a whole. Teetering mechanism 504 may allow propulsor to rotate about axis B. Cyclic 204 may allow propulsor blade 502 to rotate about axis A.

Additional information on teetering mechanisms can be found in U.S. patent application Ser. No. 17/852,229, filed on Jun. 28, 2022, and entitled “TEETERING PROPULSOR ASSEMBLY OF AN ELECTRIC VERTICAL TAKEOFF AND LANDING AIRCRAFT”.

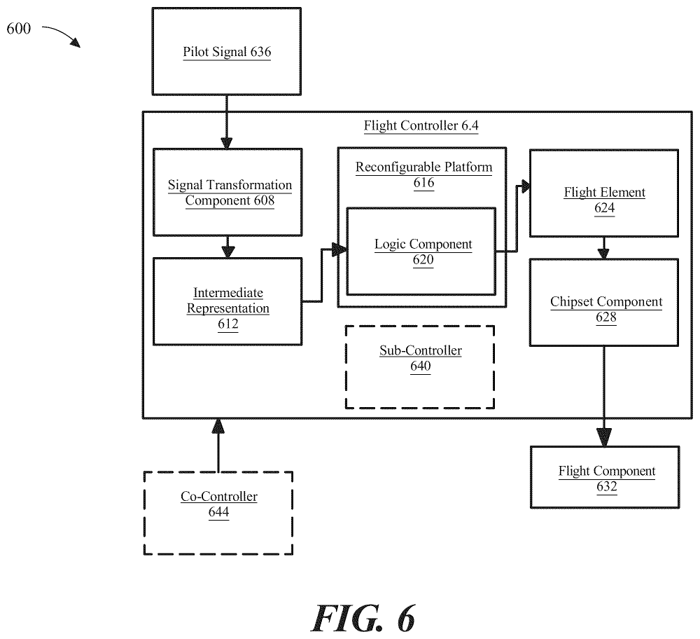

Now referring to FIG. 6, an exemplary embodiment 600 of a flight controller 604 is illustrated. As used in this disclosure a “flight controller” is a computing device of a plurality of computing devices dedicated to data storage, security, distribution of traffic for load balancing, and flight instruction. Flight controller 604 may include and/or communicate with any computing device as described in this disclosure, including without limitation a microcontroller, microprocessor, digital signal processor (DSP) and/or system on a chip (SoC) as described in this disclosure. Further, flight controller 604 may include a single computing device operating independently, or may include two or more computing device operating in concert, in parallel, sequentially or the like; two or more computing devices may be included together in a single computing device or in two or more computing devices. In embodiments, flight controller 604 may be installed in an aircraft, may control the aircraft remotely, and/or may include an element installed in the aircraft and a remote element in communication therewith.

In an embodiment, and still referring to FIG. 6, flight controller 604 may include a signal transformation component 608. As used in this disclosure a “signal transformation component” is a component that transforms and/or converts a first signal to a second signal, wherein a signal may include one or more digital and/or analog signals. For example, and without limitation, signal transformation component 608 may be configured to perform one or more operations such as preprocessing, lexical analysis, parsing, semantic analysis, and the like thereof. In an embodiment, and without limitation, signal transformation component 608 may include one or more analog-to-digital convertors that transform a first signal of an analog signal to a second signal of a digital signal. For example, and without limitation, an analog-to-digital converter may convert an analog input signal to a I 0-bit binary digital representation of that signal. In another embodiment, signal transformation component 608 may include transforming one or more low-level languages such as, but not limited to, machine languages and/or assembly languages. For example, and without limitation, signal transformation component 608 may include transforming a binary language signal to an assembly language signal. In an embodiment, and without limitation, signal transformation component 608 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 6, signal transformation component 608 may be configured to optimize an intermediate representation 612. As used in this disclosure an “intermediate representation” is a data structure and/or code that represents the input signal. Signal transformation component 608 may optimize intermediate representation as a function of a data-flow analysis, dependence analysis, alias analysis, pointer analysis, escape analysis, and the like thereof. In an embodiment, and without limitation, signal transformation component 608 may optimize intermediate representation 612 as a function of one or more inline expansions, dead code eliminations, constant propagation, loop transformations, and/or automatic parallelization functions. In another embodiment, signal transformation component 608 may optimize intermediate representation as a function of a machine dependent optimization such as a peephole optimization, wherein a peephole optimization may rewrite short sequences of code into more efficient sequences of code. Signal transformation component 608 may optimize intermediate representation to generate an output language, wherein an “output language,” as used herein, is the native machine language of flight controller 604. For example, and without limitation, native machine language may include one or more binary and/or numerical languages.

In an embodiment, and without limitation, signal transformation component 608 may include transform one or more inputs and outputs as a function of an error correction code. An error correction code, also known as error correcting code (ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q−k−l)/2 erroneous symbols. Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

In an embodiment, and still referring to FIG. 6, flight controller 604 may include a reconfigurable hardware platform 616. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic.

Still referring to FIG. 6, reconfigurable hardware platform 616 may include a logic component 620. As used in this disclosure a “logic component” is a component that executes instructions on output language. For example, and without limitation, logic component may perform basic arithmetic, logic, controlling, input/output operations, and the like thereof. Logic component 620 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 620 may be organized according to Von Neumann and/or Harvard architecture as a non-limiting example. Logic component 620 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC). In an embodiment, logic component 620 may include one or more integrated circuit microprocessors, which may contain one or more central processing units, central processors, and/or main processors, on a single metal-oxide-semiconductor chip. Logic component 620 may be configured to execute a sequence of stored instructions to be performed on the output language and/or intermediate representation 612. Logic component 620 may be configured to fetch and/or retrieve the instruction from a memory cache, wherein a “memory cache,” as used in this disclosure, is a stored instruction set on flight controller 604. Logic component 620 may be configured to decode the instruction retrieved from the memory cache to opcodes and/or operands. Logic component 620 may be configured to execute the instruction on intermediate representation 612 and/or output language. For example, and without limitation, logic component 620 may be configured to execute an addition operation on intermediate representation 612 and/or output language.

In an embodiment, and without limitation, logic component 620 may be configured to calculate a flight element 624. As used in this disclosure a “flight element” is an element of datum denoting a relative status of aircraft. For example, and without limitation, flight element 624 may denote one or more torques, thrusts, airspeed velocities, forces, altitudes, groundspeed velocities, directions during flight, directions facing, forces, orientations, and the like thereof. For example, and without limitation, flight element 624 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 624 may denote that aircraft is following a flight path accurately and/or sufficiently.

Still referring to FIG. 6, flight controller 604 may include a chipset component 628. As used in this disclosure a “chipset component” is a component that manages data flow. In an embodiment, and without limitation, chipset component 628 may include a northbridge data flow path, wherein the northbridge dataflow path may manage data flow from logic component 620 to a high-speed device and/or component, such as a RAM, graphics controller, and the like thereof. In another embodiment, and without limitation, chipset component 628 may include a southbridge data flow path, wherein the southbridge dataflow path may manage data flow from logic component 620 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 628 may manage data flow between logic component 620, memory cache, and a flight component 632. As used in this disclosure a “flight component” is a portion of an aircraft that can be moved or adjusted to affect one or more flight elements. For example, flight component 532 may include a component used to affect the aircrafts' roll and pitch which may comprise one or more ailerons. As a further example, flight component 632 may include a rudder to control yaw of an aircraft. In an embodiment, chipset component 628 may be configured to communicate with a plurality of flight components as a function of flight element 624. For example, and without limitation, chipset component 628 may transmit to an aircraft rotor to reduce torque of a first lift propulsor and increase the forward thrust produced by a pusher component to perform a flight maneuver.

In an embodiment, and still referring to FIG. 6, a remote device and/or FPGA may generate autonomous function as a function of an autonomous machine-learning model. As used in this disclosure a “remote device” is an external device to flight controller 604. As used in this disclosure an “autonomous function” is a mode and/or function of flight controller 604 that controls aircraft automatically. As used in this disclosure an “autonomous machine-learning model” is a machine-learning model to produce an autonomous function output given flight element 624 and a pilot signal 636 as inputs; this is in contrast to a non-machine learning software program where the commands to be executed are determined in advance by a user and written in a programming language. As used in this disclosure a “pilot signal” is an element of datum representing one or more functions a pilot is controlling and/or adjusting. For example, pilot signal 636 may denote that a pilot is controlling and/or maneuvering ailerons, wherein the pilot is not in control of the rudders and/or propulsors. In an embodiment, pilot signal 636 may include an implicit signal and/or an explicit signal. For example, and without limitation, pilot signal 636 may include an explicit signal, wherein the pilot explicitly states there is a lack of control and/or desire for autonomous function. As a further non-limiting example, pilot signal 636 may include an explicit signal directing flight controller 604 to control and/or maintain a portion of aircraft, a portion of the flight plan, the entire aircraft, and/or the entire flight plan. As a further non-limiting example, pilot signal 636 may include an implicit signal, wherein flight controller 604 detects a lack of control such as by a malfunction, torque alteration, flight path deviation, and the like thereof. In an embodiment, and without limitation, pilot signal 636 may include one or more explicit signals to reduce torque, and/or one or more implicit signals that torque may be reduced due to reduction of airspeed velocity. In an embodiment, and without limitation, pilot signal 636 may include one or more local and/or global signals. For example, and without limitation, pilot signal 636 may include a local signal that is transmitted by a pilot and/or crew member. As a further non-limiting example, pilot signal 636 may include a global signal that is transmitted by air traffic control and/or one or more remote users that are in communication with the pilot of aircraft. In an embodiment, pilot signal 636 may be received as a function of a tri-state bus and/or multiplexor that denotes an explicit pilot signal should be transmitted prior to any implicit or global pilot signal.

In some embodiments, autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 624. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 604 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 604 will control the ailerons and/or rudders. As used in this disclosure “non-autonomous mode” is a mode that denotes a pilot will control aircraft and/or maneuvers of aircraft in its entirety.

Still referring to FIG. 6, autonomous machine-learning model may include one or more autonomous machine-learning processes such as supervised, unsupervised, or reinforcement machine-learning processes that flight controller 604 and/or a remote device may or may not use in the generation of autonomous function. Autonomous machine-learning process may include, without limitation machine learning processes such as simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naïve bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

In an embodiment, and still referring to FIG. 6, autonomous machine learning model may be trained as a function of autonomous training data, wherein autonomous training data may correlate a flight element, pilot signal, and/or simulation data to an autonomous function. For example, and without limitation, a flight element of an airspeed velocity, a pilot signal of limited and/or no control of propulsors, and a simulation data of required airspeed velocity to reach the destination may result in an autonomous function that includes a semi-autonomous mode to increase thrust of the propulsors. Autonomous training data may be received as a function of user-entered valuations of flight elements, pilot signals, simulation data, and/or autonomous functions. Autonomous training data may be received by one or more remote devices and/or FPGAs that at least correlate a flight element, pilot signal, and/or simulation data to an autonomous function. Autonomous training data may be received in the form of one or more user-entered correlations of a flight element, pilot signal, and/or simulation data to an autonomous function.

Still referring to FIG. 6, flight controller 604 may receive an autonomous function from a remote device and/or FPGA that utilizes one or more autonomous machine learning processes as described above. For example, and without limitation, a remote device may include a computing device, external device, processor, FPGA, microprocessor and the like thereof. Remote device and/or FPGA may perform the autonomous machine-learning process using autonomous training data to generate autonomous function and transmit the output to flight controller 604. Remote device and/or FPGA may transmit a signal, bit, datum, or parameter to flight controller 604 that at least relates to autonomous function. Additionally or alternatively, autonomous machine-learning model may include one or more autonomous machine-learning processes that a field-programmable gate array (FPGA) may or may not use in the generation of autonomous function. Additionally or alternatively, the remote device and/or FPGA may provide an updated machine-learning model. For example, and without limitation, an updated machine-learning model may be comprised of a firmware update, a software update, an autonomous machine-learning process correction, and the like thereof. As a non-limiting example a software update may incorporate a new simulation data that relates to a modified flight element. Additionally or alternatively, the updated machine learning model may be transmitted to the remote device and/or FPGA, wherein the remote device and/or FPGA may replace the autonomous machine-learning model with the updated machine-learning model and generate the autonomous function as a function of the flight element, pilot signal, and/or simulation data using the updated machine-learning model. The updated machine-learning model may be transmitted by the remote device and/or FPGA and received by flight controller 604 as a software update, firmware update, or corrected autonomous machine-learning model. For example, and without limitation autonomous machine learning model may utilize a neural net machine-learning process, wherein the updated machine-learning model may incorporate a gradient boosting machine-learning process.

Still referring to FIG. 6, flight controller 604 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 6, flight controller 604 may include, but is not limited to, for example, a cluster of flight controllers in a first location and a second flight controller or cluster of flight controllers in a second location. Flight controller 604 may include one or more flight controllers dedicated to data storage, security, distribution of traffic for load balancing, and the like. Flight controller 604 may be configured to distribute one or more computing tasks as described below across a plurality of flight controllers, which may operate in parallel, in series, redundantly, or in any other manner used for distribution of tasks or memory between computing devices. For example, and without limitation, flight controller 604 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by Math Works, Natick, Massachusetts, USA In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

In an embodiment, and still referring to FIG. 6, control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 632. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 6, the plurality of flight controllers may include a master bus controller. As used in this disclosure a “master bus controller” is one or more devices and/or components that are connected to a bus to initiate a direct memory access transaction, wherein a bus is one or more terminals in a bus architecture. Master bus controller may communicate using synchronous and/or asynchronous bus control protocols. In an embodiment, master bus controller may include flight controller 604. In another embodiment, master bus controller may include one or more universal asynchronous receiver-transmitters (UART). For example, and without limitation, master bus controller may include one or more bus architectures that allow a bus to initiate a direct memory access transaction from one or more buses in the bus architectures. As a further non-limiting example, master bus controller may include one or more peripheral devices and/or components to communicate with another peripheral device and/or component and/or the master bus controller. In an embodiment, master bus controller may be configured to perform bus arbitration. As used in this disclosure “bus arbitration” is method and/or scheme to prevent multiple buses from attempting to communicate with and/or connect to master bus controller. For example and without limitation, bus arbitration may include one or more schemes such as a small computer interface system, wherein a small computer interface system is a set of standards for physical connecting and transferring data between peripheral devices and master bus controller by defining commands, protocols, electrical, optical, and/or logical interfaces. In an embodiment, master bus controller may receive intermediate representation 612 and/or output language from logic component 620, wherein output language may include one or more analog-to-digital conversions, low bit rate transmissions, message encryptions, digital signals, binary signals, logic signals, analog signals, and the like thereof described above in detail.

Still referring to FIG. 6, master bus controller may communicate with a slave bus. As used in this disclosure a “slave bus” is one or more peripheral devices and/or components that initiate a bus transfer. For example, and without limitation, slave bus may receive one or more controls and/or asymmetric communications from master bus controller, wherein slave bus transfers data stored to master bus controller. In an embodiment, and without limitation, slave bus may include one or more internal buses, such as but not limited to a/an internal data bus, memory bus, system bus, front-side bus, and the like thereof. In another embodiment, and without limitation, slave bus may include one or more external buses such as external flight controllers, external computers, remote devices, printers, aircraft computer systems, flight control systems, and the like thereof.

In an embodiment, and still referring to FIG. 6, control algorithm may optimize signal communication as a function of determining one or more discrete timings. For example, and without limitation master bus controller may synchronize timing of the segmented control algorithm by injecting high priority timing signals on a bus of the master bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 6, flight controller 604 may also be implemented using a “shared nothing” architecture in which data is cached at the worker, in an embodiment, this may enable scalability of aircraft and/or computing device. Flight controller 604 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers.

Still referring to FIG. 6, flight controller may include a sub-controller 640. As used in this disclosure a “sub-controller” is a controller and/or component that is part of a distributed controller as described above; for instance, flight controller 604 may be and/or include a distributed flight controller made up of one or more sub-controllers. For example, and without limitation, sub-controller 640 may include any controllers and/or components thereof that are similar to distributed flight controller and/or flight controller as described above. Sub-controller 640 may include any component of any flight controller as described above. Sub-controller 640 may be implemented in any manner suitable for implementation of a flight controller as described above. As a further non-limiting example, sub-controller 640 may include one or more processors, logic components and/or computing devices capable of receiving, processing, and/or transmitting data across the distributed flight controller as described above. As a further non-limiting example, sub-controller 640 may include a controller that receives a signal from a first flight controller and/or first distributed flight controller component and transmits the signal to a plurality of additional sub-controllers and/or flight components.

Still referring to FIG. 6, flight controller may include a co-controller 644. As used in this disclosure a “co-controller” is a controller and/or component that joins flight controller 604 as components and/or nodes of a distributer flight controller as described above. For example, and without limitation, co-controller 644 may include one or more controllers and/or components that are similar to flight controller 604. As a further non-limiting example, co-controller 644 may include any controller and/or component that joins flight controller 604 to distributer flight controller. As a further non-limiting example, co-controller 644 may include one or more processors, logic components and/or computing devices capable of receiving, processing, and/or transmitting data to and/or from flight controller 604 to distributed flight control system. Co-controller 644 may include any component of any flight controller as described above. Co-controller 644 may be implemented in any manner suitable for implementation of a flight controller as described above.

In an embodiment, and with continued reference to FIG. 6, flight controller 604 may be designed and/or configured to perform any method, method step, or sequence of method steps in any embodiment described in this disclosure, in any order and with any degree of repetition. For instance, flight controller 604 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

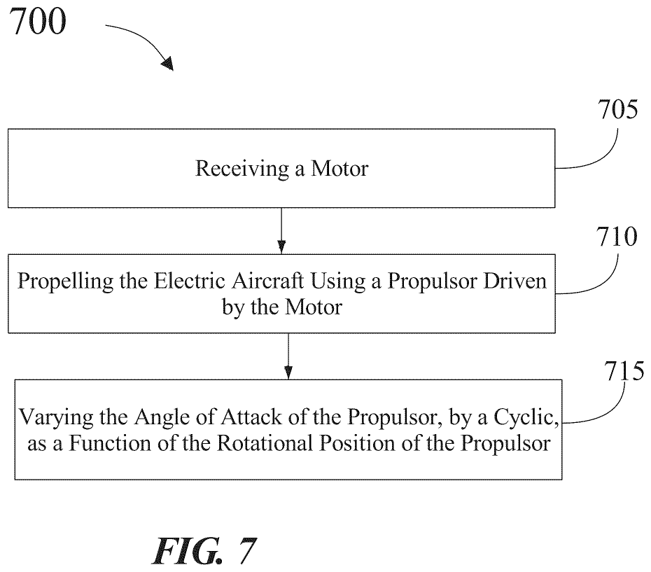

Now referring to FIG. 7, a method 700 of propulsor cyclic control on an electric aircraft is shown. Method 700 may be configured to reduce asymmetric loads due to flight. Electric aircraft may be an eVTOL. Step 705 of method 700 includes receiving a motor. This step may be implemented without limitation as described in FIGS. 1-6.

Step 710 includes propelling the electric aircraft using a propulsor driven by the motor. Propulsor may include a lift propulsor. Propulsor may include one or more solid blades. This step may be implemented without limitation as described in FIGS. 1-6.

Step 715 of method 700 includes varying the angle of attack of the propulsor, by a cyclic, as a function of the rotational position of the propulsor. The cyclic may be configured to mitigate forces from edgewise flight. Varying angle of attack of the propulsor may include adjusting a rotor. This step may be implemented without limitation as described in FIGS. 1-6.

Method 700 may also include adjusting a max change in pitch of a propulsor as a function of a cyclic control. This may be achieved using a flight controller communicatively connected with the propulsor and the cyclic. Cyclic control may be positioned in a fuselage of the aircraft. Max change in pitch may be adjusted as a function of a pilot input. Flight controller may control a feedback mechanism of the cyclic. This step may be implemented without limitation as described in FIGS. 1-6.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

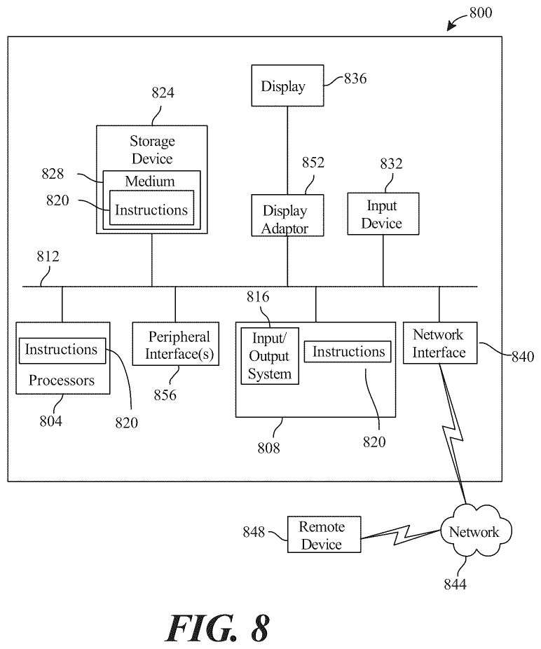

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

1. A system, comprising:
an electric motor configured to drive a shaft having a rotational axis;
a vertical lift propulsor coupled to the shaft and driven by the electric motor and configured to generate vertical thrust for powering an aircraft, the vertical lift propulsor comprising a rigid structure formed as a single element that includes a hub and at least two rigid, fixed-pitch blades that extend outwardly from the hub, wherein the electric motor is configured to rotate the vertical lift propulsor in a propulsor plane of rotation that is substantially perpendicular to the rotational axis of the shaft;
a flight controller configured to vary an angle of attack of the vertical lift propulsor as a function of a rotational position of the vertical lift propulsor to lower forces on the vertical lift propulsor associated with edgewise flight; and
a teetering mechanism configured to allow deflection of the vertical lift propulsor in and out of the propulsor plane of rotation, about a teetering axis that is perpendicular to the rotational axis of the shaft.

2. The system of claim 1, wherein the flight controller is configured to vary the angle of attack of the vertical lift propulsor to reduce asymmetric loads on the at least two rigid, fixed-pitch blades due to edgewise flight.

3. The system of claim 1, wherein the system is configured to power an electric vertical takeoff and landing aircraft.

4. The system of claim 1, wherein the flight controller is communicatively connected with the vertical lift propulsor,
and wherein the flight controller is configured to adjust a limit by which the angle of attack of the vertical lift propulsor can be varied in response to a control command generated by a cyclic control of the flight controller.

5. The system of claim 4, wherein the limit is adjusted as a function of a pilot input.

6. The system of claim 1, wherein the flight controller includes a cyclic control configured to generate cyclic control commands,
and wherein the flight controller is positioned in a fuselage of an electric aircraft.

7. The system of claim 1, wherein the vertical lift propulsor is one of a plurality of vertical lift propulsors powering an electric aircraft, with a plurality of electric motors including the electric motor each driving a respective vertical lift propulsor, and
wherein the flight controller is configured to enable independent adjustment of respective angles of attack of each of the plurality of vertical lift propulsors.

8. The system of claim 1, wherein the hub is defined at a central portion of the single element between the at least two rigid, fixed-pitch blades.

9. The system of claim 1, wherein the teetering mechanism is configured to allow deflection of the at least two rigid, fixed-pitch blades in response to asymmetrical forces applied to the vertical lift propulsor during a transition of flight modes of the aircraft.

10. The system of claim 1, wherein the system is configured to function while the aircraft operates in a wing-borne flight mode and in a thrust-borne flight mode, and
wherein the flight controller is configured to generate at least one cyclic control command for adjusting the angle of attack of the vertical lift propulsor based on at least one of an airspeed of the aircraft or a sensed load on the vertical lift propulsor.

11. A method, comprising:
generating, by a vertical lift propulsor driven by an electric motor, vertical thrust for powering an aircraft, the vertical lift propulsor being coupled to the electric motor by a shaft such that the shaft and the vertical lift propulsor rotate about a rotational axis, the vertical lift propulsor including at least two fixed-pitch blades extending radially from a hub, wherein the at least two fixed-pitch blades and the hub are formed as a rigid single element;
generating, by a flight controller, at least one cyclic control command to vary an angle of attack of the vertical lift propulsor to lower forces on the vertical lift propulsor during a transition phase of flight, between a wing-borne mode and a thrust-borne mode of operation of the aircraft;
varying, in response to the at least one cyclic control command, the angle of attack of the vertical lift propulsor as a function of a rotational position of the vertical lift propulsor by rotating the vertical lift propulsor about a pitch axis that is perpendicular to the rotational axis; and
allowing, by a teetering mechanism, deflection of the at least two fixed-pitch blades about a teetering axis that is perpendicular to the rotational axis of the shaft and different than the pitch axis.

12. The method of claim 11, wherein varying the angle of attack of the vertical lift propulsor includes adjusting a rotor.

13. The method of claim 11, wherein the at least one cyclic control command is generated based on reducing asymmetric loads on the vertical lift propulsor due to edgewise flight.

14. The method of claim 11, further comprising:
adjusting a limit by which the angle of attack of the vertical lift propulsor can be varied as a function of a cyclic control communicatively connected to the flight controller,
wherein the flight controller is communicatively connected to the vertical lift propulsor.

15. The method of claim 14, wherein adjusting the limit is based on a pilot input.

16. The method of claim 14, further comprising:
positioning the cyclic control in a fuselage of the aircraft.

17. The method of claim 11, wherein the vertical lift propulsor is one of a plurality of vertical lift propulsors, and wherein:
generating vertical thrust by the vertical lift propulsor includes generating vertical thrust by the plurality of vertical lift propulsors respectively driven by a plurality of electric motors including the electric motor to power the aircraft; and
varying the angle of attack of the vertical lift propulsor includes independently varying respective angles of attack of each of the plurality of vertical lift propulsors in response to the at least one cyclic control command.

18. The method of claim 11, wherein generating the at least one cyclic control command includes generating the at least one cyclic control command based on at least one of an airspeed of the aircraft or a sensed load on the vertical lift propulsor.

19. A system, comprising:
an electric motor configured to drive a shaft about an axis of rotation;
a vertical lift propulsor coupled to the electric motor by the shaft and configured to rotate about the axis of rotation of the shaft in response to a force generated by the electric motor, to generate vertical thrust for powering an aircraft, the vertical lift propulsor comprising a rigid structure formed as a single element that includes a hub and a plurality of fixed-pitch blades that extend outwardly from the hub;
a flight controller configured to generate a cyclic control command to vary an angle of attack of the vertical lift propulsor in response to at least one of a sensed airspeed of the aircraft or a sensed load on the vertical lift propulsor during a transition phase of flight of the aircraft, between operation in a wing-borne flight mode and a thrust-borne flight mode of the aircraft, to reduce loads on the vertical lift propulsor; and
a teetering mechanism configured to allow deflection of the plurality of fixed-pitch blades about a teetering axis that is substantially perpendicular to the axis of rotation of the shaft.

20. The system of claim 19, wherein the flight controller is configured generate the cyclic control command in response to a change in the sensed airspeed or a change in the sensed load.
